(19) United States
(12) Patent Application Publication
(10) Pub. No.: US 2009/0114876 A1
(43) Pub. Date: May 7, 2009

(54) ANTIFREEZE COMPOSITION

(75) Inventors: Fernando Horacio Garcia, Follonica (IT); Maria Fernanda Garcia, Follonica (IT)

Correspondence Address: DENNISON, SCHULTZ & MACDONALD, 1727 KING STREET, SUITE 105, ALEXANDRIA, VA, 22314, US

(73) Assignee: La Perla S.r.I., Melzo (IT)

(21) Appl. No.: 12/296,303

(22) PCT Filed: Apr. 4, 2007
(86) PCT No.: PCT/IB07/00881

§ 371 Date: Nov. 14, 2008

(30) Foreign Application Priority Data
Apr. 5, 2006 (IT) PI2006A000046

(51) Int. Cl. C09K 3/18

(52) U.S. Cl. 252/70

(57) ABSTRACT

An antifreeze composition comprising one or more metal chlorides, in particular, calcium chloride and magnesium chloride, and a solution having an alkaline pH in which at least one of the following ions is dissolved: Bromide (Br⁻), Bicarbonate (HCO³⁻), Borate (BO₃³⁻), Silicate (SiO³⁻), Fluoride (F⁻), Iodine (I⁻). this composition is capable of providing an effective antifreeze action, for example on roads, airstrips and vehicle windows, also in conditions of extremely cool temperatures. In fact, the composition remains in the liquid state even at very low temperature reducing, in particular, the environmental impact with respect to the solutions of prior art. This is possible because the interaction existing between a metal bivalent ion 10, such as Ca²⁺, or Mg²⁺, and a chloride ion (Cl⁻) 20, in the antifreeze composition brings the ions at a high balancing distance “R”. This is due to the presence of at least one weak ion 15, for example Bicarbonate (HCO³⁻), Borate (BO₃³⁻), Iodine (I⁻), Fluoride (F⁻), etc. that interacts with the ions of the bivalent metal and of the chloride.

### FIELD OF THE INVENTION

The present invention relates to an antifreeze composition for avoiding the production of ice, or removing ice, from surfaces of different type, such as roads, pavements, airstrips, vehicle windows, hinges of freezers, industrial machines, etc.

### DESCRIPTION OF THE PRIOR ART

Methods are known and traditionally used for avoiding the production of ice, or removing ice, from surfaces roads, pavements, airstrips, etc. provides salt, usually sodium chloride, calcium chloride or magnesium chloride.

In particular, the use of sodium chloride is preferred with respect to the use of calcium chloride, for its low cost and its easy availability. The use of calcium chloride is, furthermore, limited for dissolving the ice already formed, since on the asfalto asciutto tends to form a slippery layer.

The process through which the addition of salt causes the water freezing point to decrease comprises, synthetically, the dissociation of the salt molecules into ions and their electrostatic link to the water molecules. When the temperature drops below zero, the water starts to form crystals of ice, which however do not have the possibility of growing for the presence of the ions.

However, the salts above cited have different drawbacks. Firstly, they provide an effective antifreeze action only above a temperature of about −5° C., whereas they loose efficiency for lower temperatures.

Furthermore, such substances have a considerable environmental impact, since once dissolved they are adsorbed by the ground and can pollute the roots of plants, affecting the absorption of water.

Another drawback of the above described salts is their high rate of corrosiveness due mainly to their acidity. This can cause phenomena of corrosion, for example for vehicles that move on the roads on which the salt has been scattered.

Other substances commonly used as antifreeze agents are magnesium chloride, potassium acetate, sodium acetate, ammonium phosphate, ammonium nitrate, alcohols having low molecular weight and urea.

However, also these substances have a considerable environmental impact. In particular, the alcohols with low molecular weight volatilize easily and pollute then the surrounding atmosphere.

### SUMMARY OF THE INVENTION

It is then a feature of the invention to provide an antifreeze composition capable of providing an effective antifreeze action also in conditions of extremely cold temperatures.

It is another feature of the invention to provide an antifreeze composition having low environmental impact.

It is a further feature of the invention to provide an antifreeze composition for avoiding the drawbacks of the antifreeze compositions of prior art.

These and other features are accomplished with one exemplary antifreeze composition, according to the invention, comprising:
at least one metal chloride; whose main feature is to provide furthermore:
an aqueous solution having an alkaline pH in which at least one of the following ions is dissolved: Bromide (Br⁻), Bicarbonate (HCO³⁻), Borate (BO₃³⁻), Silicate (Sio³⁻), Fluoride (F⁻), Iodine (I⁻).

In particular, the aqueous solution may have a pH set between 7.2 and 10.5.

Advantageously, the aqueous solution has a pH set between 7.3 and 9.5.

Preferably, the aqueous solution has a pH set between 7.5 and 8.5.

Advantageously, the or each ion of the an aqueous solution having an alkaline pH has the following concentration:
Bromide ions (Br⁻): set between 10 mg/l and 500 mg/l;
Bicarbonate ions (HCO³⁻): set between 0.1 mg/l and 500 mg/l.

Borate ions (BO₃³⁻): set between 10 mg/l and 200 mg/l;
Silicate ions (SiO³⁻): set between 0.01 mg/l and 5 mg/l;
Fluoride ions (F⁻): set between 0.01 mg/l and 5 mg/l;
Iodine ions (I⁻): set between 0.01 mg/l and 5 mg/l.

Furthermore, the an aqueous solution having an alkaline pH can comprise at least one of the following ions in the concentration indicated:
ions Cl⁻: set between 15000 mg/l and 30000 mg/l;
ions Na⁺: set between 5000 mg/l and 20000 mg/l;
ions SO₄²⁻: set between 1000 mg/l and 5000 mg/l;
ions Mg²⁺: set between 500 mg/l and 3000 mg/l;
ions Ca²⁺: set between 500 mg/l and 3000 mg/l;
ions K⁺: set between 100 mg/l and 1000 mg/l.

Advantageously, the aqueous solution is sea water.

In particular, the or each chloride can be a metal alkaline chloride or a earth metal alkaline chloride.

Advantageously, the or each chloride is selected from the group comprised of:
calcium chloride;
magnesium chloride;
sodium chloride;
potassium chloride;
lithium chloride;
a combination thereof.

Preferably, the chloride compound is a combination of calcium chloride and magnesium chloride.

In particular, the antifreeze composition can provide:
calcium chloride: in an amount set between 5% and 50% by weight;
magnesium chloride: in an amount set between 5% and 50% by weight;
an aqueous solution having alkaline pH: in an amount set between 50% and 95% by weight.

Advantageously, the antifreeze composition provides:
calcium chloride: in an amount set between 10% and 40% by weight;
magnesium chloride: in an amount set between 5% and 40% by weight;
an aqueous solution having alkaline pH: in an amount set between 50% and 80% by weight.

Preferably, the antifreeze composition provides:
calcium chloride: in an amount set between 25% and 35% by weight;
magnesium chloride: in an amount set between 5% and 15% by weight;
an aqueous solution having alkaline pH: in an amount set between 55% and 65% by weight.

In particular, the cited metal chlorides, such as calcium chloride and magnesium chloride, are strong electrolytes. Therefore in the aqueous solution they dissociate completely into metal ions, for example Ca²⁺ and Cl⁻ and Mg²⁺ and Cl⁻ respectively. These ions in the aqueous solution are surrounded by weak electrolytes having an opposite charge ivi present, such as bromide ions and bicarbonate ions, etc. producing a “shield” effect, as provided by the of Debye-Hückel theory. The “shield” effect made by the weak electrolytes increases, in particular, the distance between the calcium ions (Ca²⁺) and the chloride ions (Cl⁻) from one side, and between the magnesium ions (Mg²⁺) and the chloride ions (Cl⁻) from another side. Therefore, in accordance with the Coulomb's law, the electrostatic force between the ions is reduced and then the ions same remain in solution also for cold temperature instead of crystallizing.

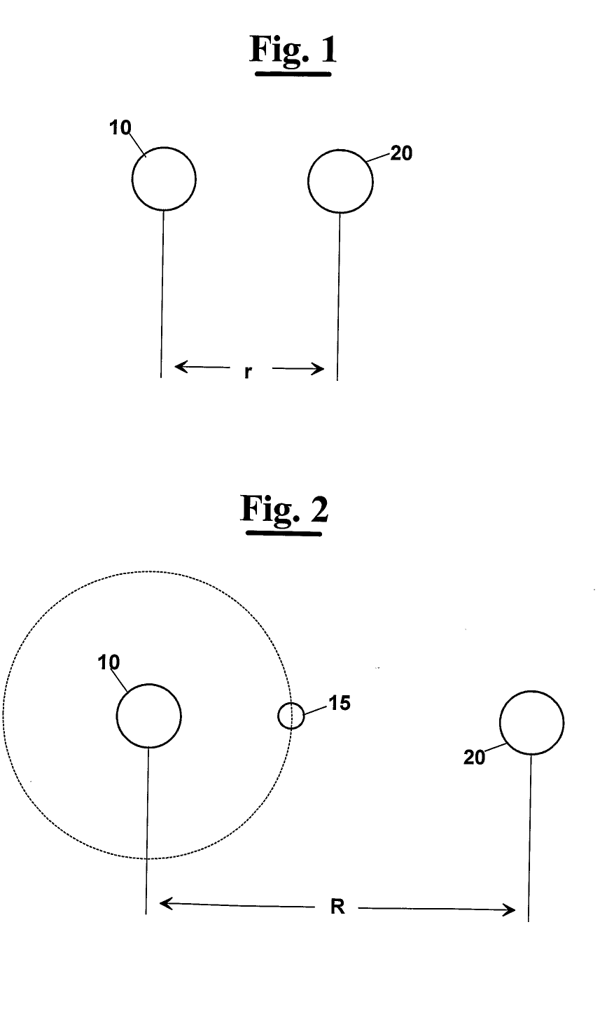

The above described features are diagrammatically shown in FIGS. 1 and 2 attached.

In FIG. 1 is diagrammatically shown the situation between the ions having opposite sign present in an aqueous solution of a metal chloride bivalent. In particular, the distance between the ions having opposite sign, i.e. between a metal ion 10, such as a calcium ion Ca²⁺, or a magnesium ion Mg²⁺, and the chloride ion (Cl⁻) 20 corresponds to the distance at balance where the electrostatic attraction force is the same as the repulsive force. More in detail, the attraction force between anions and cations is directly proportional to the product of the electric charge of the ions in play and is inversally proportional to the square of their distance as expressed by the known equation:

F=−k·q₁·q₂/r².

Under action of this force the ions approach to one another, but the approaching step not will proceed beyond a certain distance because the electronic shields of the two ions have equal charge, i.e. negative, is repulsive.

In FIG. 2, instead, the situation is shown of the interaction between a metal bivalent ion 10, such as Ca²⁺, or Mg²⁺, and a chloride ion (Cl⁻) 20 in an antifreeze composition, according to the invention. As shown in FIG. 2, the distance “R” between the metal bivalent ion 10 and the chloride ion (Cl⁻) 20 is higher than the distance “r” between the two ions of the aqueous solution of FIG. 1. This is obtained for the presence of at least one weak ion 15, for example Bicarbonate (HCO³⁻), Borate (BO₃³⁻) Iodine (I⁻), Fluoride (F⁻), etc. which interact with the ions of the bivalent metal and of the chloride ion.

Therefore, the antifreeze composition according to the invention remains in the liquid state also for very low temperatures, about −80° C. allowing to provide the above advantages.

The invention will now be described in a way not limitative, through the following examples.

### EXAMPLE 1

An antifreeze composition is prepared comprising the 40% by weight of magnesium chloride (MgCl₂) and the 60% by weight of sea water at pH=8. The composition remains in the liquid state up to −60° C.

### EXAMPLE 2

An antifreeze composition is prepared comprising 4% by weight of calcium chloride (CaCl₂), 36% by weight of magnesium chloride (MgCl₂) and 60% by weight of sea water at pH=8. The composition remains in the liquid state up to −60° C.

### EXAMPLE 3

An antifreeze composition is prepared comprising 16% by weight of calcium chloride (CaCl₂), 24% by weight of magnesium chloride (MgCl₂) and 60% by weight of sea water at pH=8. The composition remains in the liquid state up to −60° C.

### EXAMPLE 4

An antifreeze composition is prepared comprising 20% by weight of calcium chloride (CaCl₂), 20% by weight of magnesium chloride (MgCl₂) and 60% by weight of sea water at pH=8. The composition remains in the liquid state up to −70° C.

### EXAMPLE 5

An antifreeze composition is prepared comprising 24% by weight of calcium chloride (CaCl₂), 16% by weight of magnesium chloride (MgCl₂) and 60% by weight of sea water at pH=8. The composition remains in the liquid state up to −80° C.

### EXAMPLE 6

An antifreeze composition is prepared comprising 28% by weight of calcium chloride (CaCl₂), 12% by weight of magnesium chloride (MgCl₂) and 60% by weight of sea water at pH=8. The composition remains in the liquid state up to −90° C.

### EXAMPLE 7

An antifreeze composition is prepared comprising 36% by weight of calcium chloride (CaCl₂), 4% by weight of magnesium chloride (MgCl₂) and 60% by weight of sea water at pH=8. The composition remains in the liquid state up to −8° C.

### EXAMPLE 8

An antifreeze composition is prepared comprising 40% by weight of calcium chloride (CaCl₂), and 60% by weight of sea water at pH=8. The composition remains in the liquid state up to −80° C.

In table 1 are reported, finally, the results of tests on some antifreeze compositions, according to the invention.

In particular, the antifreeze compositions, indicated in table with the Roman numerals from I to XI, comprise a solution of sea water at pH=8, calcium chloride (CaCl₂) and magnesium chloride (MgCl₂) in variable proportions. The concentration (% p/p) of each component is expressed in grams of solute for 100 grams of composition.

The physical state of each composition at different temperatures is indicated.

TABLE 1

| | | | Sea | | | | | | |
|---|---|---|---|---|---|---|---|---|---|
| | CaCl₂ | MgCl₂ | water | Negative temperature state of the solution | | | | | |
| Composition | % p/p | % p/p | % p/p | −20° C. | −30° C. | −51° C. | −60° C. | −70° C. | −80° C. |
| I | 0 | 40 | 60 | L | L | L | S | S | S |
| II | 4 | 36 | 60 | L | L | L | S | S | S |
| III | 8 | 32 | 60 | L | L | L | S | S | S |
| IV | 12 | 28 | 60 | L | L | L | S | S | S |
| V | 16 | 24 | 60 | L | L | L | S | S | S |
| VI | 20 | 20 | 60 | L | L | L | L | S | S |
| VII | 24 | 16 | 60 | L | L | L | L | L | S |
| VIII | 28 | 12 | 60 | L | L | L | L | L | L |
| IX | 32 | 8 | 60 | L | L | L | L | L | S |
| X | 36 | 4 | 60 | L | L | L | L | L | S |
| XI | 40 | 0 | 60 | L | L | L | L | L | S |

1. Antifreeze composition comprising:
at least one metal chloride; characterised in that it comprises, furthermore:
an aqueous solution having an alkaline pH in which at least one of the following ions is dissolved: Bromide (Br⁻), Bicarbonate (HCO³⁻), Borate (BO₃³⁻), Silicate (SiO³⁻), Fluoride (F⁻), Iodine (I⁻).

2. Antifreeze composition, according to claim 1, wherein said aqueous solution has a pH set between 7.2 and 10.5.

3. Antifreeze composition, according to claim 1, wherein said aqueous solution has a pH set between 7.3 and 9.5.

4. Antifreeze composition, according to claim 1, wherein said aqueous solution has a pH set between 7.5 and 8.5.

5. Antifreeze composition, according to claim 1, wherein said or each ion of said aqueous solution having an alkaline pH has the following concentration:
bromide ions (Br⁻): set between 10 mg/l and 500 mg/l;
bicarbonate ions (HCO³⁻): set between 0.1 mg/l and 500 mg/l;
borate ions (BO₃³⁻): set between 10 mg/l and 200 mg/l;
silicate ions (SiO³⁻): set between 0.01 mg/l and 5 mg/l;
fluoride ions (F⁻): set between 0.01 mg/l and 5 mg/l;
Iodine ions (I⁻): set between 0.01 mg/l and 5 mg/l.

6. Antifreeze composition, according to claim 1, wherein said aqueous solution comprises, furthermore, at least one of the following ions in the indicated concentration:
Cl⁻ ions: set between 15000 mg/l and 30000 mg/l;
Na⁺ ions: set between 5000 mg/l and 20000 mg/l;
SO₄²⁻ ions: set between 1000 mg/l and 5000 mg/l;
Mg²⁺ ions: set between 500 mg/l and 3000 mg/l;
Ca²⁺ ions: set between 100 mg/l and 3000 mg/l;
K⁺ ions: set between 100 mg/l and 1000 mg/l;

7. Antifreeze composition, according to claim 1, wherein said aqueous solution is sea water.

8. Antifreeze composition, according to claim 1, wherein said or each chloride is selected from the group comprised of: a metal alkaline chloride, a metal earth alkaline chloride.

9. Antifreeze composition, according to claim 1, wherein said at least one chloride is selected from the group comprised of:
calcium chloride;
magnesium chloride;
sodium chloride;
potassium chloride;
lithium chloride;
a combination thereof.

10. Antifreeze composition, according to claim 1, wherein said at least one chloride is a combination of calcium chloride and magnesium chloride.

11. Antifreeze composition, according to claim 1, comprising:
calcium chloride: in an amount set between 5% and 50% by weight;
magnesium chloride: in an amount set between 5% and 50% by weight;
an aqueous solution having alkaline pH: in an amount set between 50% and 95% by weight.

12. Antifreeze composition, according to claim 1, comprising:
calcium chloride: in an amount set between 10% and 40% by weight;
magnesium chloride: in an amount set between 5% and 40% by weight;
an aqueous solution having alkaline pH: in an amount set between 50% and 80% by weight.

13. Antifreeze composition, according to claim 1, comprising:
calcium chloride: in an amount set between 25% and 35% by weight;
magnesium chloride: in an amount set between 5% and 15% by weight;
an aqueous solution having alkaline pH: in an amount set between 55% and 65% by weight.
